(19) United States
(12) Patent Application Publication
(10) Pub. No.: US 2015/0325048 A1
(43) Pub. Date: Nov. 12, 2015

(54) SYSTEMS, METHODS, AND COMPUTER-READABLE MEDIA FOR GENERATING A COMPOSITE SCENE OF A REAL-WORLD LOCATION AND AN OBJECT

(71) Applicant: Mobile R&D Inc., Austin, TX (US)

(72) Inventors: Ryan Travis Engle, Austin, TX (US); Adam Gravois, Austin, TX (US); Darren Turetzky, Cedar Park, TX (US)

(73) Assignee: Mobile R&D Inc., Austin, TX (US)

(21) Appl. No.: 14/271,062

(22) Filed: May 6, 2014

(51) Int. Cl. G06T 19/00; G06T 1/00; G06T 15/50

(52) U.S. Cl. CPC G06T 19/006; G06T 15/50; G06T 1/0007; G06T 2207/20208

(57) ABSTRACT

Provided are systems, methods, and computer-readable media for generating a composite scene of a real-world location and an object. An image, such as a panoramic view, of a real-world location and an image of an object are obtained. HDR lighting properties of the real-world location image are determined and used to render the object. The object is positioned in the real-world location image to generate a composite scene that such that the rendered object appears to be physically present in the real-world location.

### BACKGROUND OF THE INVENTION

1. Field of the Invention

This invention relates generally to image processing and, more particularly, to realistically rendering an object in an image of a real-world location.

2. Description of the Related Art

Computer-based mapping services and corresponding applications provide different types of information to end users and devices. For example, a mapping service may provide locations of businesses, directions from one location to another, and maps of geographic areas in response to user requests. Such mapping services may enable a user to locate and obtain information on nearly any real-world location. However, these mapping services and applications provide users with limited interaction with the real-world locations locatable and viewable using the mapping services.

### SUMMARY OF THE INVENTION

Various embodiments of methods, computer-readable media, and systems for generating a composite scene of a real-world location and an object are provided herein. In some embodiments, a computer-implemented method is provided that includes obtaining, by one or more processors, an image of a real-world location from a mapping service, the image having one or more high dynamic range (HDR) lighting properties and determining, by one or more processors, the values of the HDR lighting properties from the image. The computer-implemented method further comprises storing, by one or more processors, the HDR values in an alpha component of the image and obtaining, by one or more processors, an image of an object, the object having material properties. The computer-implemented method also includes rendering, by one or more processors, the object image using the material properties and HDR lighting based on the HDR values, positioning, by one or more processors, the object image within the real-world location image, and generating, by one or more processors, a composite scene of the real-world location and the object image.

In some embodiments, non-transitory tangible computer-readable storage medium having executable computer code stored thereon for generating a composite scene of a real-world location and object is provided. The code includes a set of instructions that causes one or more processors to perform the following: obtaining, by one or more processors, an image of a real-world location from a mapping service, the image having one or more high dynamic range (HDR) lighting properties and determining, by one or more processors, the values of the HDR lighting properties from the image. The code further includes a set of instructions that causes one or more processors to perform the following: storing, by one or more processors, the HDR values in an alpha component of the image and obtaining, by one or more processors, an image of an object, the object having material properties. The code further includes a set of instructions that causes one or more processors to perform the following: rendering, by one or more processors, the object image using the material properties and HDR lighting based on the HDR values, positioning, by one or more processors, the object image within the real-world location image, and generating, by one or more processors, a composite scene of the real-world location and the object image.

Additionally, in some embodiments, a system is provided that includes one or more processors and a non-transitory tangible computer-readable memory having executable computer code stored thereon. The code includes a set of instructions that causes one or more processors to perform the following: obtaining, by one or more processors, an image of a real-world location from a mapping service, the image having one or more high dynamic range (HDR) lighting properties and determining, by one or more processors, the values of the HDR lighting properties from the image. The code further includes a set of instructions that causes one or more processors to perform the following: storing, by one or more processors, the HDR values in an alpha component of the image and obtaining, by one or more processors, an image of an object, the object having material properties. The code further includes a set of instructions that causes one or more processors to perform the following: rendering, by one or more processors, the object image using the material properties and HDR lighting based on the HDR values, positioning, by one or more processors, the object image within the real-world location image, and generating, by one or more processors, a composite scene of the real-world location and the object image.

### BRIEF DESCRIPTION OF THE DRAWINGS

FIG. 1 is a diagram that illustrates a user device displaying a composite scene in accordance with one or more embodiments of the present technique;

FIG. 2 is a block diagram of a system for generating a composite scene in accordance with an embodiment of the present invention;

FIGS. 3A and 3B are flowcharts of a process for generating a composite scene in accordance with an embodiment of the present scene;

FIGS. 4A and 4B are diagrams depicting generation of a composite scene from a real-world location image and a 3D object image; and

FIG. 5 is a block diagram of a computer in accordance with an embodiment of the present invention.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

As discussed in more detail below, provided in some embodiments are systems, methods, and computer-readable media for generating a composite scene of a real-world location and an object. In some embodiments, an image of a real-world location having HDR lighting properties is obtained, such as from a mapping service. An image of an object (e.g., a 3D object) having material properties is also obtained. The HDR lighting properties and values are determined from the real-world location image. The object image is rendered using the material properties and HDR lighting based on the HDR values. The object image is then positioned in the real-world location image to generate a composite scene such that the rendered object appears to be physically present in the real-world location viewable in the real-world location image. The composite scene may be displayed on a user device and enables a user to easily visualize the object in the real-world location.

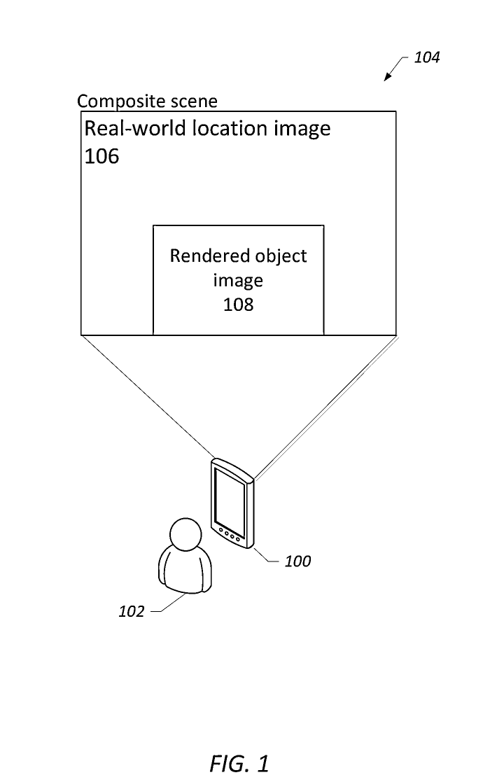

FIG. 1 is a diagram that depicts a user device 100 of a user 102 in accordance with an embodiment of the present invention. The user device 100 may include laptop computers, tablet computers, desktop computers, smartphones, wearable computers, personal digital assistants, game consoles, or any other suitable devices. As described further below, the user device 100 may generate and display a composite scene 104 that combines a real-world location image 106 (e.g., a panoramic view of a real-world location) and a rendered object 108. In other embodiments, as discussed below, the composite scene 104 may be generated on another computer and transmitted to the user device 104 for display. The real-world location image 106 may include real-world image properties 110. In some embodiments, the real-world image properties include high dynamic range (HDR) lighting properties. The rendered object 108 is rendered based on the real-world image properties 110 such that the rendered object 108 looks realistic when presented within the real-world location image 106 (e.g., the rendered object 108 appears to be physically present in the real-world location of the image 106.

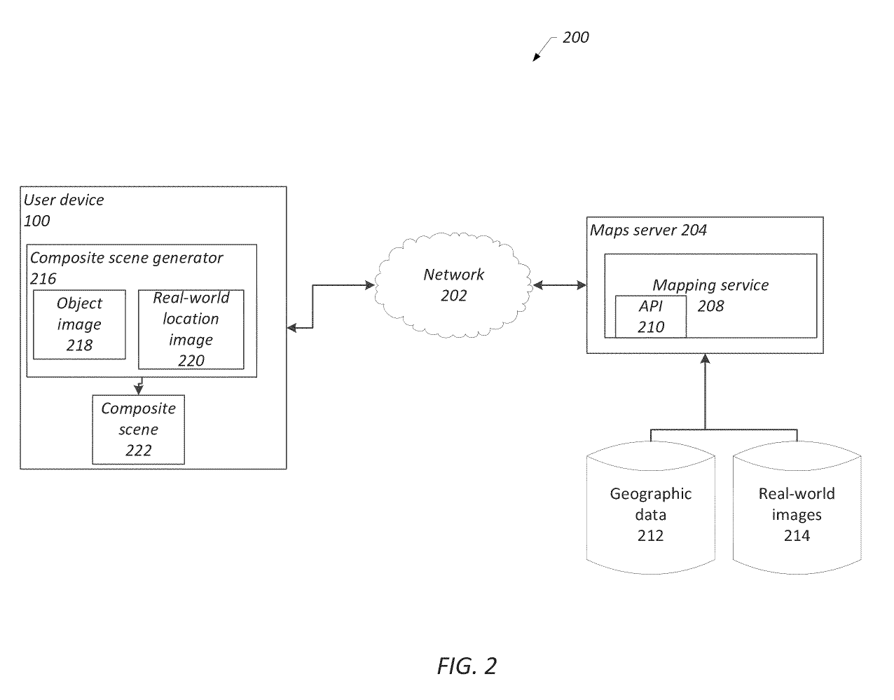

FIG. 2 is a block diagram of a system 200 that includes the user device 100 of the user 102, a network 202, and a maps server 204. A user may use the user device 100 to retrieve information, view interactive geographic maps, take photographs, and so on. The user device 100 may send requests to and receive responses from the maps server 204 via the network 202. For example, the user device 100 may request real-world location information from the map server 204, including a real-world location image, in response to user input. In some embodiments, the maps server 204 may be accessed via a web browser, while in other embodiments the map server 204 may be accessed using a different application (e.g., a maps application).

The maps server 204 may include a single server or multiple servers and may represent a physical hardware component or virtual server. Such servers may include a web server, an application server, a database server, or other servers. The maps server 204 may be, in some embodiments, any suitable physical and virtual arrangement of computers, such as computers in a data processing center, a distributed computing environment, or other arrangements. In such embodiments, the computers may communicate using the network 202 or other networks.

As shown in FIG. 2, the user device 100 and maps server 102 may communicate via a network 202. The communication may be performed via a wired or wireless interface to the network 202 using any suitable networking technology, and the network 202 itself may be a wired or wireless network. The network 202 may include multiple networks, and suitable networks may include the Internet, an intranet, a local area network (LAN), a wide area network (WAN), or any combination thereof. The user device 100 and the maps server 204 may each communicate over additional networks separate from and in addition to the network 202. For example, in some embodiments the user device 100 may include a smartphone that is capable of communicating over both a Wi-Fi network and a cellular network.

The maps server 204 may include or provide access to a mapping service 208 that receives requests from users and provides requested data, such as geographic maps, directions, real-world location images, and so on. The mapping service 208 may also include or provide access to an application programming interface (API) 210 that enables applications and services, such as those executing on the user device 100, to access features and data provided by the mapping service 208. For example, in some embodiments, various properties of a real-world location image used in the processing described herein may be obtained via the API 210.

The maps server 204 may also include or have access to geographic data 212 and real-world images 214. As will be appreciated, the geographic data 212 and real-world images 214 may each be stored in an appropriate data structure, such as a database or other data repository. In some embodiments, these data structures may be stored on the maps server 204 or may be stored on another server and accessible by the server 204 via the network 202 or another network. In some instances, the real-world images 214 are obtained by a provider of the mapping service 214. For example, the real-world images 214 may be captured by continuations photography of real-world locations along streets and other thoroughfares.

The geographic data 212 may be accessed by the mapping service 208 to provide requested geographic data to the user device 100 in response to requests from the device 100. Similarly, the real-world images 214 may be accessed by the mapping service 208 to provide an image of a real-world location when requested by the user device 100. In some embodiments, the mapping service 208 may be Google Maps manufactured by Google of Mountain View, Calif., Bing Maps manufactured by Microsoft of Redmond, Wash., or other suitable mapping services.

As shown in FIG. 2, the user device 100 may include a composite scene generator 216 (e.g., an application stored in memory of the user device 100 and executed by one or more processors of the user device 100). In some embodiments, the composite scene generator 216 may be a standalone native or non-native application stored in memory and executed by one or more processors of the user device 100. In other embodiments, the composite scene generator 216 may be a module, extension, plugin, or other addition to an existing application (e.g., a web browser or maps application). The composite scene generator 216 may obtain a real-world location image 220 (e.g., a panoramic view of a real-world location) from the mapping service 208, such as via the API 210. The composite scene generator 216 may also obtain an object image 218 (e.g., an image of a vehicle, a building, a sign, and so on). The object image 218 may be obtained from any suitable source, such as a local storage of the user device, from another server coupled to the network 202 (e.g., “cloud” storage accessible by the user device 100), and so on.). The real-world location image 220 may be in any suitable format, such as JPEG, Exif, TIFF, RAW, GIF, BMP, PNG, and so on. Similarly, the object image 214 may be provided as an image in any suitable format, such as JPEG, Exif, TIFF, RAW, GIF, BMP, PNG, and so on

As described further below, the composite scene generator 216 processes the real-world image 220 and the object image 218 to generate the composite scene 222. After generation of the composite scene 222, the composite scene 222 may be displayed to the user on a display of the user device 100. As previously mentioned, the composite scene 222 enables a user to easily visualize an object in a real-world location (e.g., visualizing a car in front of the user's residence, visualizing a sign or other display in front of the user's business, etc.).

It should be appreciated that the real-world location image may be obtained from other sources. For example, in some embodiments the real-world location image may be obtained from a different server or service than the maps server 204 and mapping service 208 described above. In some embodiments, the real-world location image may be obtained from a social networking service, a microblogging service, a web page or other document, or other suitable sources. In some embodiments, the real-world location image may be obtained from a photograph taken by the user device 100 and retrieved from local storage or “cloud” storage.

In some embodiments, the composite scene generator 216 may be executed by the maps server 204 or another server. In such embodiments, the user device 100 may send the real-world location image 220, the object image 218, or both to the maps server 204 or other server executing the composite scene generator 216. In some embodiments, the user device 100 may only identify the location of the real-world location image 220, the object image 218, or both to the maps server 216 or other server executing the composite scene generator 216. In these embodiments, the maps server 216 or other server executing the composite scene generator 216 may generate the composite scene 222 according to the techniques described herein and send the composite scene to the user device 100, such as via the network 202, for display by the user device 100.

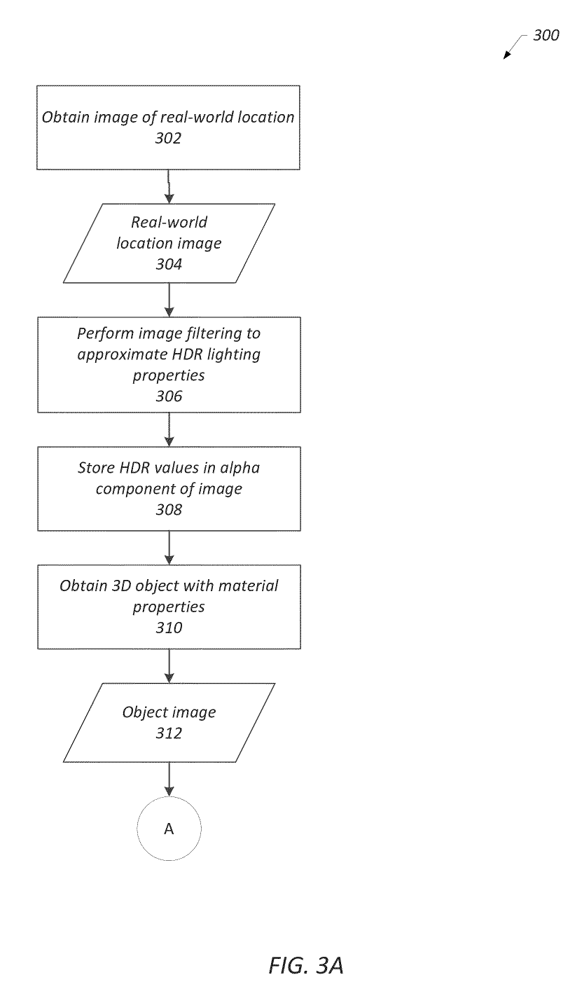

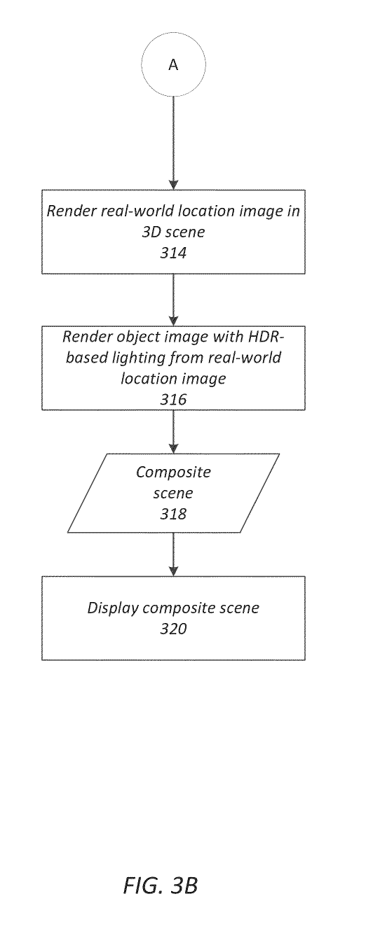

FIGS. 3A and 3B depict a process 300 for generating a composite scene in accordance with an embodiment of the present invention. Some or all steps of the process 300 may be implemented as executable computer code stored on a non-transitory tangible computer-readable storage medium and executed by one or more processors of a special-purpose machine, e.g., a computer programmed to execute the code. For example, in some embodiments some or all steps of the process 300 may be implemented in the composite scene generator described above and may be performed on a user device or on a server. In some embodiments, various steps of the process 300 may be distributed between a user device and server.

Initially, an image 304 of a real-world location is obtained (block 302). In some embodiments, the image 304 is a panoramic view of the real-world location. The image 304 may be a relatively high resolution image having HDR lighting properties (referred to as an HDR environment map). In some embodiments, as described above, the real-world location image 304 may be obtained from a mapping service, such as via an API of a mapping service. In other embodiments, the real-world location image 304 may be captured via a camera and stored on a user device. In yet other embodiments, the real-world location image 304 may be obtained from other sources (e.g., an image accessible via a webpage or other resource accessible over a network).

Next, image filtering is performed on the real-world location image to approximate the HDR lighting properties of the image (block 306). In some embodiments, reflections and specular data of the HDR lighting properties may be created from the image 304. Additionally, a low-resolution softened version of the HDR lighting properties for use in diffuse (i.e., non-reflective) lighting. The low-resolution softened version (referred to as a low-dynamic range environment map) may be created using a blurring algorithm developed for spherical environment maps. In some embodiments, the blurring algorithm is a Gaussian blur (i.e., blurring using a Gaussian function). The values of the HDR properties are stored in the alpha component of the real-world location image (block 308). An object image 312 (e.g., a polygonal model of a real-world 3D object) with material properties is then obtained (block 310), such as from local storage of a user device or via a network. In some embodiments, the material properties of the object image 312 may be approximated as five texture maps: diffuse color, specular color, specular gloss, facing reflect, and transparency. In some embodiment, additional texture maps using the same shading model may be used, such as coat color, incandescence, or other suitable maps.

The real-world image location is rendered as a 3D scene using the HDR properties and values from the real-world location image (block 314). The object image is then rendered with HDR-based lighting using the HDR lighting properties from the real-world location image (block 316) and positioned in the 3D scene to generate the composite scene 318. In some embodiments, the HDR lighting may be determined programmatically by, for example, searching above the horizon in the image and assuming any portions of the scene with a blue hue are sky and any portions of the scene that are white in the sky are clouds. In some embodiments, the horizon is determined at a percentage depth in the image, such as about 70% or less. A base brightness is set, and the brightness is increased for specific portions of the image, such as those portions that are pure white, resulting in the sun and clouds to be significantly brighter than the sky or the ground after rendering.

In some embodiments, the rendering is performed according to the process described below. Each visible surface point (e.g., pixel) on the surface of the object are located. The surface normal, and the corresponding texture map values for each located point are determined. The transparency is determined by multiplying the 3D scene real-world location image (resulting from the sum of the previous rendering (shading operations)) by the transparency RGB value of each point. As a result, areas which are black in the transparency texture will turn black, making them effectively opaque and prepared for the diffuse and specular values to be added on top. Areas which are white or a shade of color will leave some or all of the background visible, giving the appearance of a transparent surface when add diffuse and specular values are added on top. The diffuse may be calculated by multiplying the diffuse texture value of each located point by the point on the diffuse environment map that the surface normal points to.

The specular may be calculated by multiplying the specular texture map value by the facing reflect factor multiplied by the specular environment sample. The specular texture map value is the RGB value of the specular color texture map at the located point of the object surface. For example, a metal surface will have specular colors that match the diffuse or perceived colors, while a plastic surface will not (e.g., gold metal has golden reflections whereas a gold-colored plastic object has white reflections). The facing reflect factor may be determined by obtaining the triangle's normal's angle relative to the camera. For example, for triangles that are at a glancing angle to the camera (e.g., perpendicular), the facing reflect factor is 1 or fully reflective. For triangles that are facing directly at the camera (parallel to the camera), the facing reflect factor is equal to the value of the facing reflect texture map sample. For angles in between these two angles, the facing reflect factor of a point may be determined by interpolating between 1 and the facing reflect value.

Finally, the specular environment sample may be calculated by sampling the HDR lighting properties (HDR environment map) at the angle equal to the reflection of the viewing ray of a point. For example, the angle from the camera to the surface point may be obtained and reflected around the surface normal, and the resulting angle may be used to pick a sample from the HDR environment map.

In some embodiments, blurry reflections may be simulated by replacing the HDR environment map with the softened version, depending on the specular gloss texture at a point. For example, if the specular gloss texture value is 1, the original environment may be used. If the specular gloss value is less than 1, the softened version of the environment may be used (as creating via the blurring algorithm mentioned above). In some embodiments, progressive amounts of blurriness may be stored in the environment map as a series of mipmaps to efficiently store multiple levels of blurry reflections.

As mentioned above, some embodiments may include additional texture maps for the object, such as a coat color. In such embodiments, the coat color may be applied as a second specular layer on top and may be assumed to have a facing reflect value of 0.2 (e.g., simulating the effect of clear coat on paint). In some embodiments, an incandescence texture map may be applied as an RGB texture added to the resulting map.

In some embodiments, the user may be presented with an option to manually position the object image in the composite scene. In other embodiments, the initial position of the object image may be automatically determined and the user may subsequently enter adjustments to the initial position. The composite scene depicting the real-world location and the object image visualized therein may be displayed (block 320) such as on a display of the user device.

In some embodiments, the object image may be an item purchasable from a seller. For example, in some embodiments the object image may be a vehicle purchasable from a vehicle dealer or other seller. The techniques described herein may advantageously enable a user to visualize the vehicle in the driveway or other parking area of the user's residence. In some embodiments, this feature may be provided by the dealerships or other seller to entice the user to purchase the vehicle by showing the user different vehicles (e.g., different models, colors, etc.) parked in the driveway of the user's residence. Advantageously, the techniques described herein enable a realistic depiction of the vehicle in a real-world location such as a driveway so as to increase the probability that the user purchases the vehicle. In such embodiments, the object image may be obtained from or provided by servers controlled by the seller. For example, in some embodiments a vehicle dealer may make vehicle images available for use to enable users to visualize potential purchases by viewing the vehicle image rendered in their driveway or other parking location of a residence. In some embodiments, the object image may include a hyperlink to or contact information from seller so that a user may obtain further information about a depicted object. In some embodiments, the hyperlink or contact information may be another image added to the composite scene.

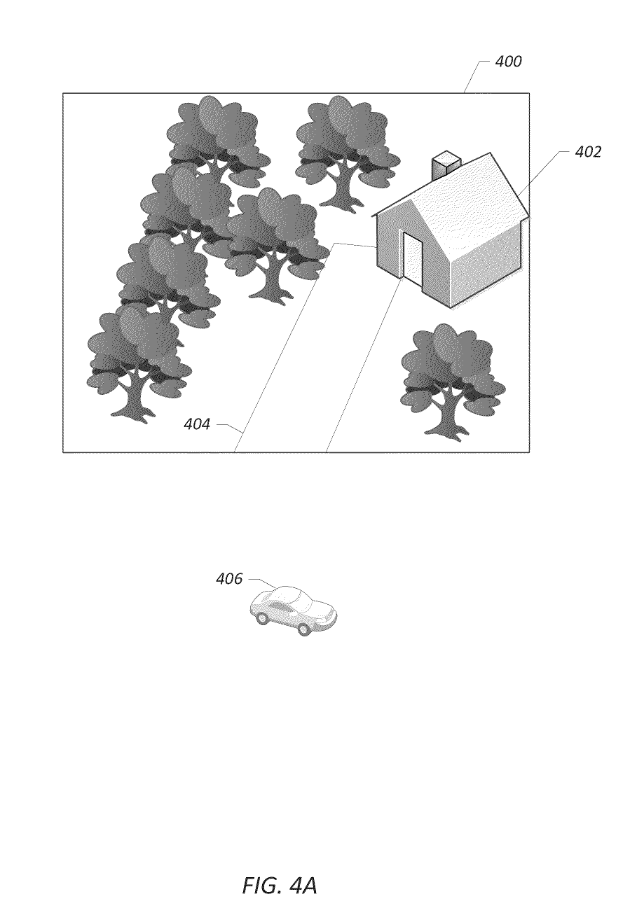

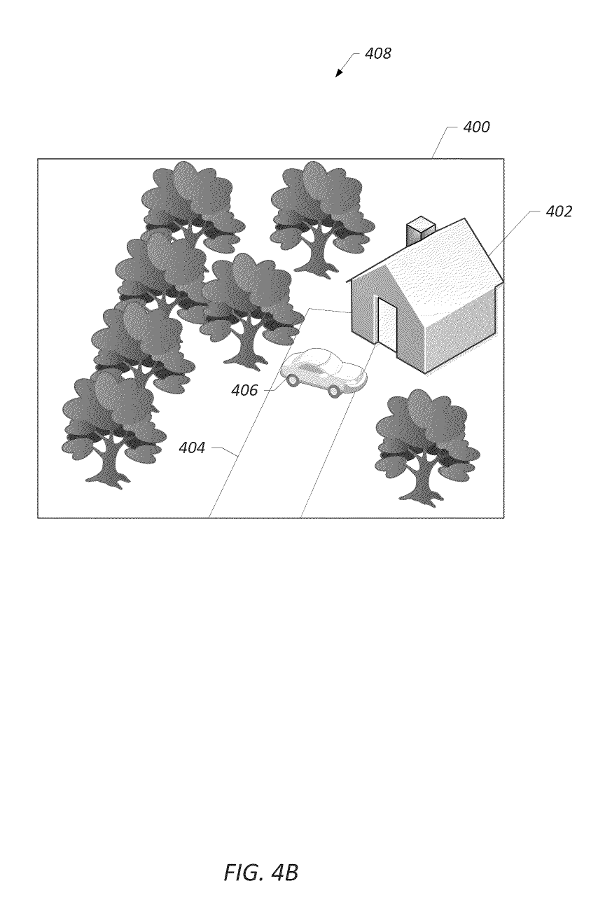

FIGS. 4A and 4B depict an example of visualizing a vehicle in a driveway of a user's residence in accordance with an embodiment of the present invention. As shown in FIG. 4A, a real-world location image 400 may include a user's residence 402 and driveway 404. The real-world location image may be obtained in a manner similar to that described above, such as from a mapping service that provides real-world location images or via capture by a user. FIG. 4A also depicts a 3D vehicle image 406, such as an image of a vehicle for purchase from a vehicle dealer. In some embodiments, for example, a dealer may distribute or enable easy acquisition of 3D vehicle images for use by a composite scene generator so that potential purchasers may easily visualize owning the vehicle at their residence or other location.

Next, as shown in FIG. 4B, the real-world location image 400 and the 3D vehicle object image 402 are combined to generate a composite scene 408. As shown in FIG. 4B, the 3D vehicle image 406 may be positioned in the appropriate parking are of the driveway 404 of the residence 402, enabling the user to visualize “owning” the vehicle and parking it at his or her residence. In some embodiments, a user may have the option to reposition the 3D vehicle image 406 anywhere in the composite scene. Additionally, in some embodiments, contact information for the vehicle dealer, a hyperlink to a vehicle dealer website, and/or other information relevant to the purchase of the vehicle may be added to the composite scene and may be selectable by the user. In some embodiments, this additional information may be included as metadata with the 3D vehicle image and usable when the vehicle image is obtained.

It should be appreciated that other embodiments may include the visualization of other objects within a real-world location. In some embodiments, an image of a building (e.g., a residence or office building) may be rendered and positioned in a composite scene of a real-world location. For example, such embodiments may enable a user to visualize a building before construction is complete. In some embodiments, an image of art or writing may be rendered and positioned on a physical structure in a composite scene of a real-world location. In some embodiments, a virtual person may be rendered and positioned in a composite scene of a real-world location. In yet other embodiments, signage, such as business or advertising signs, may be rendered and positioned in a composite scene of a real-world location to enable visualization of potential advertising or identification of a business. Similarly, other signs, street lamps, fire hydrants, and any other objects used in urban planning may be rendered and positioned in a composite scene of a real-world location to aid in design and planning or a city or other settlement. Additionally, rendered objects may be overlaid on or replace elements of existing physical structures in a composite scene, such as to enable visualization of remodeling options for an existing building or other structure. In some embodiments, unreal objects (e.g., fantasy objects such as dragons, science-fiction objects such as aliens) may be rendered and positioned in a composite scene.

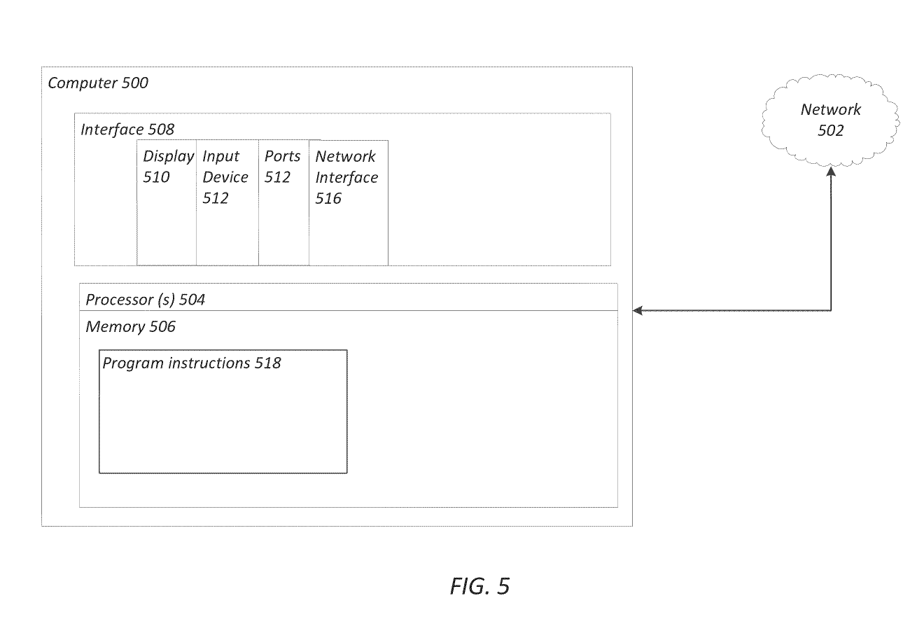

FIG. 5 depicts a computer 500, e.g., the user device 100, in accordance with an embodiment of the present invention. The computer depicted in FIG. 5, and other computers providing comparable capabilities, may be used in conjunction with the present techniques. The computer 500 may communicate over a network 502, described further below. The computer 500 may include various internal and external components that contribute to the function of the device and which may allow the computer 500 to function in accordance with the techniques discussed herein. As will be appreciated, various components of computer 500 may be provided as internal or integral components of the computer 500 or may be provided as external or connectable components. It should further be noted that FIG. 5 depicts merely one example of a particular implementation and is intended to illustrate the types of components and functionalities that may be present in computer 500.

In various embodiments, the computer 500 may be a server, a desktop computer, a laptop computer, a tablet computer, a smartphone, or other types of computers. As shown in FIG. 5, the computer 500 may include one or more processors 504 and memory 506. Additionally, the computer 500 may include, for example, an interface 508, a display 510, an input device 512, input/output ports 514 and a network interface 516.

The display 510 may include a cathode ray tube (CRT) display, a liquid crystal display (LCD), an organic light emitting diode (OLED) display, or other types of displays. The display 510 may display a user interface (e.g., a graphical user interface) and may display various function and system indicators to provide feedback to a user, such as power status, call status, memory status, etc. In some embodiments, the display 510 may include a touch-sensitive display (referred to as a “touch screen). In such embodiments, the touch screen may enable interaction with the computer via a user interface displayed on the display 510. In some embodiments, the display 510 may display a user interface for implementing the techniques described above, such as, for example, creating subscriptions, generating node identifiers, removing subscriptions, removing node identifiers, viewing logs, and so forth.

The one or more processors 504 may provide the processing capability required to execute the operating system, programs, user interface, and functions of the computer 500. The one or more processors 500 may include microprocessors, such as “general-purpose” microprocessors, a combination of general and special purpose microprocessors, and Application-Specific Integrated Circuits (ASICs). The computer 500 may thus be a single processor system or a multiple processor system. The one or more processors 500 may include single-core processors and multicore processors and may include graphics processors, video processors, and/or related chip sets.

The memory 506 may be accessible by the processor 502 and other components of the computer 500. The memory 506 (which may include tangible non-transitory computer readable storage mediums) may include volatile memory and non-volatile memory accessible by the processor 502 and other components of the computer 500. The memory 506 may store a variety of information and may be used for a variety of purposes. For example, the memory 506 may store the firmware for the computer 500, an operating system for the computer 500, and any other programs or executable code necessary for the computer 500 to function. The memory 506 may include volatile memory, such as random access memory (RAM) and may also include non-volatile memory, such as ROM, a solid state drive (SSD), a hard drive, any other suitable optical, magnetic, or solid-state storage medium, or a combination thereof.

The memory may store executable computer code that includes program instructions 518 executable by the one or more processors 502 to implement one or more embodiments of the present invention. For example, the process 300 described above may be implemented in program instructions 518. Similarly, the composite scene generator 216 described above may be implemented in program instructions 518. The program instructions 518 may include a computer program (which in certain forms is known as a program, software, software application, script, or code). Thus, in some embodiments program instructions 518 may include instructions for a composite scene generator. A computer program may be written in any suitable programming language and may include a unit suitable for use in a computing environment, including as a stand-alone program, a module, a component, a subroutine, etc., that may or may not correspond to a file in a file system. The program instructions 518 may be deployed to be executed on computers located locally at one site or distributed across multiple remote sites and interconnected by a communication network (e.g., network 502).

The interface 508 may include multiple interfaces and may couple various components of the computer 500 to the processor 502 and memory 504. In some embodiments, the interface 508, the processor 502, memory 504, and one or more other components of the computer 500 may be implemented on a single chip. In other embodiments, these components and/or their functionalities may be implemented on separate chips.

The computer 500 also includes a user input device 512 that may be used to interact with and control the computer 500. In general, embodiments of the computer 500 may include any number of user input devices 512, such as a keyboard, a mouse, a trackball, a digital stylus or pen, buttons, switches, or any other suitable input device. The input device 512 may be operable with a user interface displayed on the computer 500 to control functions of the computer 500 or of other devices connected to or used by the computer 500. For example, the input device 500 may allow a user to navigate a user interface, input data to the computer 500, select data provided by the computer 500, and direct the output of data from the computer 500.

The computer 500 may also include an input and output port 514 to enable connection of devices to the computer 500. The input and output 514 may include an audio port, universal serial bus (USB) ports, AC and DC power connectors, serial data ports, and so on. Further, the computer 500 may use the input and output ports to connect to and send or receive data with other devices, such as other computers, printers, and so on.

The computer 500 depicted in FIG. 5 also includes a network interface 516, such as a network interface card (NIC), wireless (e.g., radio frequency) receivers, etc. For example, the network interface 516 may include known circuitry for communicating with communication networks via electromagnetic signals transmitted over a wired or wireless connection. Such circuitry may include, for example, antennas, amplifiers, transceivers, receivers, processors, and so on. The network interface 516 may communicate with various communication networks (e.g., network 502), such as the Internet, an intranet, a cellular telephone network, a wireless local area network (LAN) a metropolitan area network (MAN), or other suitable communication networks. The network interface 516 may implement any suitable communications standard, protocol and/or technology, including wired Ethernet, wireless Ethernet (Wi-Fi) ((e.g., IEEE 502.11a, IEEE 502.11b, IEEE 502.11g and/or IEEE 502.11n), a 3G network (e.g., based upon the IMT-2000 standard), high-speed downlink packet access (HSDPA), wideband code division multiple access (W-CDMA), code division multiple access (CDMA), time division multiple access (TDMA), a 4G network (e.g., IMT Advanced, Long-Term Evolution Advanced (LTE Advanced), etc.), and any other suitable communications standard, protocol, or technology.

Various portions or sections of systems and methods described herein include or are executed on one or more computers similar to computer 400 and programmed as special-purpose machines executing some or all steps of methods described above as executable computer code. Further, processes and modules described herein may be executed by one or more processing systems similar to that of computer 500.

Various embodiments may further include receiving, sending or storing instructions and/or data implemented in accordance with the foregoing description upon a computer-accessible medium. Generally speaking, a computer-accessible/readable storage medium may include a non-transitory storage media such as magnetic or optical media, (e.g., disk or DVD/CD-ROM), volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” includes a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A computer-implemented method for generating a composite scene of a real-world location and object, comprising:
obtaining, by one or more processors, an image of a real-world location from a mapping service, the image having one or more high dynamic range (HDR) lighting properties;
determining, by one or more processors, the values of the HDR lighting properties from the image;
storing, by one or more processors, the HDR values in an alpha component of the image;
obtaining, by one or more processors, an image of an object, the object having material properties;
rendering, by one or more processors, the object image using the material properties and HDR lighting based on the HDR values;
positioning, by one or more processors, the object image within the real-world location image; and
generating, by one or more processors, a composite scene of the real-world location and the object image.

2. The computer-implemented method of claim 1, wherein obtaining by one or more processors, the image of a real-world location comprises sending, over a network, a location request corresponding to the real-world location from a user device to a mapping service.

3. The computer-implemented method of claim 2, wherein obtaining by one or more processors, the image of a real-world location comprises sending, over a network, a request for a view of the real-world location from the user device to the mapping service.

4. The computer-implemented method of claim 1, wherein the object comprises a 3D object.

5. The computer-implemented method of claim 1, comprising displaying the composite scene on a display of a user device.

6. The computer-implemented method of claim 1, wherein the object comprises a vehicle purchasable from a seller and the real-world location includes a residence of a user having a parking location.

7. The computer-implemented method of claim 6, wherein positioning, by one or more processors, the object image within the real-world location image comprises positioning the object image in the parking location of the vehicle residence.

8. A non-transitory tangible computer-readable storage medium having executable computer code stored thereon for generating a composite scene of a real-world location and object, the code comprising a set of instructions that causes one or more processors to perform the following:
obtaining, by one or more processors, an image of a real-world location from a mapping service, the image having one or more high dynamic range (HDR) lighting properties;
determining, by one or more processors, the values of the HDR lighting properties from the image;
storing, by one or more processors, the HDR values in an alpha component of the image;
obtaining, by one or more processors, an image of an object, the object having material properties;
rendering, by one or more processors, the object image using the material properties and HDR lighting based on the HDR values;
positioning, by one or more processors, the object image within the real-world location image; and
generating, by one or more processors, a composite scene of the real-world location and the object image.

9. The non-transitory tangible computer-readable storage medium of claim 8, wherein obtaining by one or more processors, the image of a real-world location comprises sending, over a network, a location request corresponding to the real-world location from a user device to a mapping service.

10. The non-transitory tangible computer-readable storage medium of claim 9, wherein obtaining by one or more processors, the image of a real-world location comprises sending, over a network, a request for a view of the real-world location from the user device to the mapping service.

11. The non-transitory tangible computer-readable storage medium of claim 8, wherein the object comprises a 3D object.

12. The non-transitory tangible computer-readable storage medium of claim 8, the code comprising a set of instructions that causes one or more processors to perform the following: displaying the composite scene on a display of a user device.

13. The non-transitory tangible computer-readable storage medium of claim 8, wherein the object comprises a vehicle purchasable from a seller and the real-world location includes a residence of a user having a parking location.

14. The non-transitory tangible computer-readable storage medium of claim 13, wherein positioning, by one or more processors, the object image within the real-world location image comprises positioning the object image in the parking location of the vehicle residence.

15. A system for generating a composite scene of a real-world location and object, comprising:
one or more processors; and
a non-transitory tangible computer-readable memory having executable computer code stored thereon, the code comprising a set of instructions that causes one or more processors to perform the following:
obtaining, by one or more processors, an image of a real-world location, the image having one or more high dynamic range (HDR) lighting properties;
determining, by one or more processors, the values of the HDR lighting properties from the image;
storing, by one or more processors, the HDR values in an alpha component of the image;
obtaining, by one or more processors, an image of an object, the object having material properties;
rendering, by one or more processors, the object image using the material properties and HDR lighting based on the HDR values;
positioning, by one or more processors, the object image within the real-world location image; and
generating, by one or more processors, a composite scene of the real-world location and the object image.

16. The system of claim 15, wherein obtaining by one or more processors, the image of a real-world location comprises sending, over a network, a location request corresponding to the real-world location from a user device to a mapping service.

17. The system of claim 16, wherein obtaining by one or more processors, the image of a real-world location comprises sending, over a network, a request for a view of the real-world location from the user device to the mapping service.

18. The system of claim 15, the code comprising a set of instructions that causes one or more processors to perform the following: displaying the composite scene on a display of a user device.

19. The system of claim 15, wherein the object comprises a vehicle purchasable from a seller and the real-world location includes a residence of a user having a parking location.

20. The system of claim 19, wherein positioning, by one or more processors, the object image within the real-world location image comprises positioning the object image in the parking location of the vehicle residence.
